(19) United States
(12) Patent Application Publication
(10) Pub. No.: US 2011/0031752 A1
(43) Pub. Date: Feb. 10, 2011

(54) MARITIME GENERATOR

(76) Inventor: Eduardo Metzen, Curitiba (BR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/919,237

(22) PCT Filed: Mar. 16, 2009
(86) PCT No.: PCT/BR09/00070

§ 371 Date: Aug. 25, 2010

(30) Foreign Application Priority Data
Mar. 18, 2008 (BR) PI0801714-0

(51) Int. Cl. F03B 13/18

(52) U.S. Cl. 290/53

(57) ABSTRACT

This device is composed by a floating platform(s) (1) that can be active or inactive in accordance with its position in the wave, being active when the crest of the wave promotes route and inactive when route to the valley of the wave descends, they are mounted (s) in a base(4) fixed to the deep one of the sea, adjusted to the level of the sea through a regulating device of height, that always keeps floating platform(s) in best position to use the advantage of the amplitude in existing waves and the tide at that moment. They will have around to be mounted the installed equipments (5) as well as the sustentation structured (6). It possesses the floating platforms(s)(1), and it is connected to rod(s) (3), that it can be a rack, for example, connected to the central axle (2), and is through the connecting rod (3) that the available energy in the nature is transmitted for the central axle (2), the floating platform (1) and its connecting rod (3) can be integrated, as one alone has asked for, and is free functioning as a piston, going up and down. Transmitting the force proceeding from the push in the floating platform (1) in its ascent movement, through the connecting rod (3) for the central axle (2), fixed to the sustentation structure (6), that this connected to the base (4), and in turn, the axle (2) to, puts into motion the installed equipments (5), through the transmission (8). Generating electric energy mainly, going up and down in accordance with the existing amplitude of the waves in the sea.

This present Pionner patent mentions the “MARITIME GENERATOR”, or more particularly to a device that, in some parts, can generate rotating movement through the transformation of the present energy in the movement of the waves of the sea. It uses two forces basically as motor energy, the push and the gravity, thus providing two movements in distinct directions, one for low and another one for top, as well as the said device is able of being used in different types of equipments can you installed through transmissions, that can only provide rotation in the two directions or in only one.

This device is composed by a floating platform(s) (1) that they can be active or inactive in accordance with its position in the wave, being active when the crest of the wave promotes route and inactive when route to the valley of the wave descends, they are mounted (s) in a base(4) fixes to the deep one of the sea, that if adjusts to the level of the sea through a regulating device of height, that always keeps floating platform(s) in best position to use the advantage of the amplitude in existing waves and the tide at that moment. They will have around to be mounted the installed equipments(5) as well as the sustentation structure(6). It possesss the floating platforms(s)(1), and its connected to rod(s) (3), that it can be a rack, for example, connected to the central axle(2), and is through the connecting rod(3) that the available energy in the nature is transmitted for the central axle(2), the floating platform(1) and its connecting rod (3) can be integrated, as one alone has asked for, and is free functioning as a piston, going up and descends. Transmitting the force proceeding from the push in the floating platform(1) in its ascent movement, through the connecting rod(3) for the central axle(2), fixed to the sustentation structure(6), that this connected to the base (4), and in turn, the axle(2) to, puts into motion the installed equipments(5), through the transmission(8). Generating electric energy mainly, going up and down in accordance with the existing amplitude of the waves in the sea. This device is adjusted in accordance with the amplitude of the waves at that moment and present conditions, adjusting itself for the present wave amplitude, through adjustable arms(7) that they are integrated to the sustentation structure(6), and these arms, for its time, regulates in the distance between floating platforms, being longer or shorter when necessary. It practically possesss a drive automatic, as soon as inserted in the sea and adjusted the amplitude of present wave, position 1, being able to be attended by an engine, if necessary. The floating platform(1) will be free in the sea, hardwired only for the connecting rod(3) to the central axle (2), is guided by the guide(9) connected to the structure of sustentation(6) for in such a way if not losing itself in the sea, being able to interact with the waves of the sea, and to transmit its force proceeding from the push generated for its characteristic of floating platform, for the central axle(2), that, in turn this hardwired to the transmissions of force(8), and to the installed equipments(5), going up gradual route to the crest of the wave, after finished this phase, the device process will be in position 2, alternating the floating platform(1) active for its subsequent one, that he was inactive, in the valley of the wave, and starts to be active when it reaches its position of ascent movement, and starts to go up of the valley for the crest of the wave. And the floating platform(1) inactive, that it meets in the crest of the wave, return its initial position by means of the gravity, descend again for the valley of the wave, being now in position 1, and thus successively. Going up and down to the “flavor” of the waves and the tide.

Therefore, the objective of the present invention is to generate tork, that can put into motion generators of electric energy, among others installed equipments, clean energy, practically inexhaustible form and without limits.

For better understanding of the present device, a description detailed of the same is made after that, making references to the attached drawings in transversal cut, where:

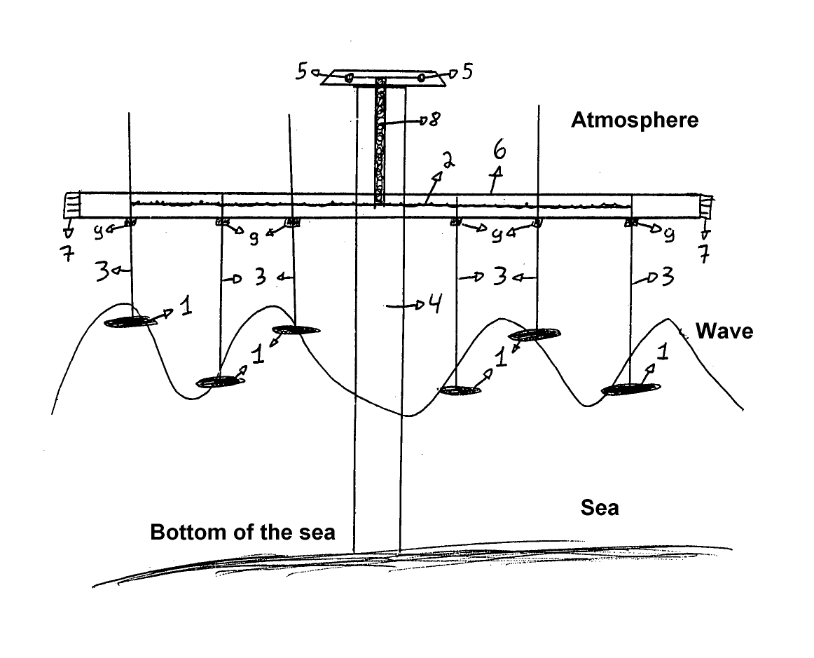

FIG. 1, it represents position 1;

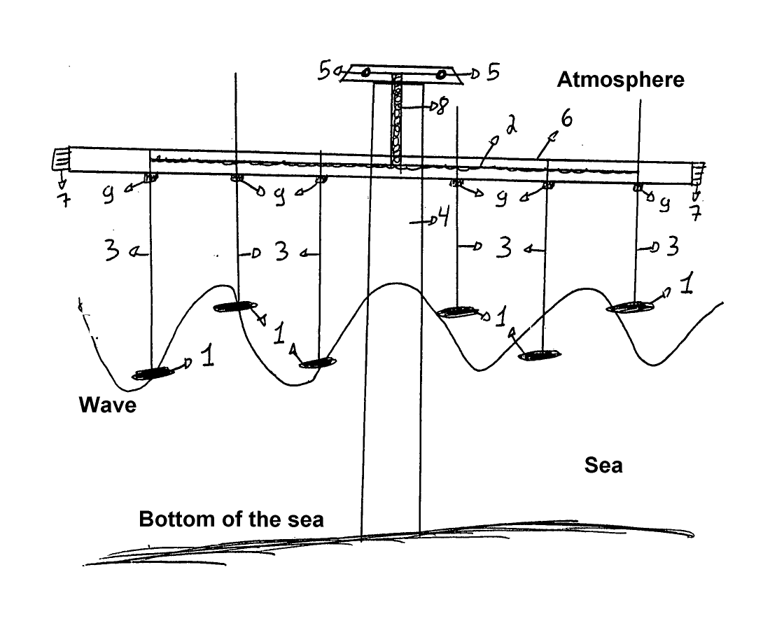

FIG. 2, it represents position 2;

In accordance with these illustrations and in its details, more particularly FIGS. 1 and 2, the device of this present Pioneer patent, MARITIME GENERATOR, are of the type manufactured with common materials, in plastic, ferrous material, etc. By means of use of adequate process. The floating platform(1) and its connecting rod(3) integrated, acts in independent way in relation to the central axle(2) is guided by the guide(9) fixed to the sustentation structure(6), and acts in accordance with the position that is situated in the wave, crest or valley. Transmitting the force generated by the push, that it acts in the floating platform(1) in its ascendant phase, to the installed equipment(5), and for being interconnected, to the central axle(2) and to the connecting rod(3), in way that the axle(2) receives the energy transmitted for the floating platform(1), and, in his turn, directs this energy for the installed equipment(5), and being thus, in this way, it can interact with the variations of the waves of the sea and generate electric energy, for example. Receiving in this way the force proceeding from the push, that is transformed into kinetic energy for the movement of the transmission(8), that they transmit the available energy in the nature for the installed equipment(5), that in his turn, they are, mainly generators of electric energy.

This present device is characterized by(s) the floating platform(s)(1) mounted(s) with(s) its connecting rod(s)(3), that it can be a rack, for example, and is guided by the guide(9), transmitting the force for central axle(2), and the base(4) fixed in the deep one of the sea. Where, in turn, the axle(2) transmits the energy of the nature through the floating platform(s)(1) to put into motion the installed equipments(5), interacting in this way with the sea. Generating energy, when the floating platform(1) promotes route the crest of the wave, receiving in this way the force proceeding from the push, that is essential for the movement of the axle(2), and later to the installed energy generators, in its majority. After this, inevitably, the floating platform(1) descends to its initial position, by means of the force of the gravity, route to the valley of the wave.

1. MARITIME GENERATOR, this device is composed by a floating platform(s) (1) that they can be active or inactive in accordance with its position in the wave, being active when the crest of the wave promotes route and inactive when route to the valley of the wave descends, they are mounted (s) in a base(4) fixes to the deep one of the sea, that if adjusts to the level of the sea through a regulating device of height, that always keeps floating platform(s) in best position to use the advantage of the amplitude in existing waves and the tide at that moment. They will have around to be mounted the installed equipments(5) as well as the sustentation structure(6). It possesss the floating platforms(s)(1), and its connected to rod(s) (3), that it can be a rack, for example, connected to the central axle(2), and is through the connecting rod(3) that the available energy in the nature is transmitted for the central axle(2), the floating platform(1) and its connecting rod (3) can be integrated, as one alone has asked for, and is free functioning as a piston, going up and descends. Transmitting the force proceeding from the push in the floating platform(1) in its ascent movement, through the connecting rod(3) for the central axle(2), fixed to the sustentation structure(6), that this connected to the base (4), and in turn, the axle(2) to, puts into motion the installed equipments(5), through the transmission(8). Generating electric energy mainly, going up and down in accordance with the existing amplitude of the waves in the sea. This device is adjusted in accordance with the amplitude of the waves at that moment and present conditions, adjusting itself for the present wave amplitude, through adjustable arms(7) that they are integrated to the sustentation structure(6), and these arms, for its time, regulates in the distance between floating platforms, being longer or shorter when necessary. It practically possesss a drive automatic, as soon as inserted in the sea and adjusted the amplitude of present wave, position 1, being able to be attended by an engine, if necessary. The floating platform(1) will be free in the sea, hardwired only for the connecting rod(3) to the central axle (2), is guided by the guide(9) connected to the structure of sustentation(6) for in such a way if not losing itself in the sea, being able to interact with the waves of the sea, and to transmit its force proceeding from the push generated for its characteristic of floating platform, for the central axle(2), that, in turn this hardwired to the transmissions of force(8), and to the installed equipments(5), going up gradual route to the crest of the wave, after finished this phase, the device process will be in position 2, alternating the floating platform(1) active for its subsequent one, that he was inactive, in the valley of the wave, and starts to be active when it reaches its position of ascent movement, and starts to go up of the valley for the crest of the wave. And the floating platform(1) inactive, that it meets in the crest of the wave, return its initial position by means of the gravity, descend again for the valley of the wave, being now in position 1, and thus successively.
CHARACTERIZED by(s) the floating platform(s)(1) mounted(s) with(s) its connecting rod(s)(3), that it can be a rack, for example, and is guided by the guide(9), transmitting the force for central axle(2), and the base(4) fixed in the deep one of the sea. Where, in turn, the axle(2) transmits the energy of the nature through the floating platform(s)(1) to put into motion the installed equipments(5), interacting in this way with the sea. Generating energy, when the floating platform(1) promotes route the crest of the wave, receiving in this way the force proceeding from the push, that is essential for the movement of the axle(2), and later to the installed energy generators, in its majority. After this, inevitably, the floating platform(1) descends to its initial position, by means of the force of the gravity, route to the valley of the wave.
